(19) United States
(12) Patent Application Publication
(10) Pub. No.: US 2023/0063276 A1
(43) Pub. Date: Mar. 2, 2023

(54) DIRECT DRIVE PLANTER WITH STEP UP VOLTAGE CONVERTER

(71) Applicant: Kinze Manufacturing, Inc., Williamsburg, IA (US)

(72) Inventors: Jamie Shults, Williamsburg, IA (US); Matthew Wilhelmi, Williamsburg, IA (US)

(21) Appl. No.: 17/823,681

(22) Filed: Aug. 31, 2022

Related U.S. Application Data
(60) Provisional application No. 63/260,847, filed on Sep. 2, 2021.

(51) Int. Cl. A01B 63/12; H02M 3/135

(52) U.S. Cl. CPC A01B 63/12; H02M 3/135

(57) ABSTRACT

An agricultural planting implement having a number of row units includes a voltage converter configured to receive an input voltage and produce an output voltage that is different than the input voltage. The voltage converter is configured to receive power directly from an agricultural vehicle configured to tow the agricultural planting implement. The voltage converter can be selectively enabled and/or disabled to supply the requisite power to electronic components located on the row units, wherein the electronic components are configured to perform at least one agricultural function. Different electronic components often require a power supply of differing voltage levels. The voltage converter provides a means to supply differing power supplies to different electronic components wherein all electrical power supplied to the electronic components originates from a power source located on the agricultural vehicle.

### CROSS REFERENCE TO RELATED APPLICATIONS

This application claims priority under 35 U.S.C. § 119 to provisional patent application U.S. Ser. No. 63/260,847 filed Sep. 2, 2021. The provisional patent application is herein incorporated by reference in its entirety, including without limitation, the specification, claims, and abstract, as well as any figures, tables, appendices, or drawings thereof.

### TECHNICAL FIELD

Aspects of the invention relate generally to apparatuses, methods, and systems for use in the agriculture industry. More particularly, but not exclusively, the invention relates to supplying appropriate power to electronic components located on an agricultural implement.

### BACKGROUND

Various electronic components are often included on row units of agricultural implements. These electronic components may perform varying agricultural functions. For example, some electronic components may act as sensors to measure soil moisture or other characteristics such as depth of a furrow. Other examples of electronic components located on a row unit of an agricultural implement may include seed meters, fans, sprayers, dispensers, fertilizers, valves, motors, planting equipment, electronic control units, and the like. Oftentimes, different electronic components, or even the same components when performing different functions, may require a power supply of differing voltage level.

Past attempts to resolve the issue of providing a differing power supply to different electronic components of agricultural implements have relied on including an alternator, generator, hydraulic pump, or some other type of heavy electrical power generating source on the agricultural implement itself. Oftentimes mechanical or hydraulic energy was transferred from an agricultural vehicle to a generator, alternator, or hydraulicly-controlled power pack located on an agricultural implement in order to generate electrical power. However, including some sort of generator, alternator, or the like on an agricultural implement, or on an agricultural vehicle configured to tow an agricultural implement, is expensive and cumbersome as alternator/generator equipment can often be heavy and bulky.

Thus, there exists a need in the art for an agricultural implement in which all electrical power supplied to the agricultural implement, including its electronic components located on the row units, can originate from a power source located on an agricultural vehicle towing the agricultural implement without having to include an extra alternator/generator on the agricultural implement. There is also a need in the art for an agricultural vehicle to provide the requisite voltage to each electronic component on an agricultural planting implement in which the electronic components require differing power supplies.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the invention to improve on or overcome the deficiencies in the art.

It is a further object, feature, and/or advantage of the invention to provide an agricultural system that supplies the appropriate power required by electronic components that are located on an agricultural planting implement and that are configured to perform at least one agricultural function.

It is still yet a further object, feature, and/or advantage of the invention to provide an agricultural system that supplies the requisite power to electronic components located on the row units of the implement without including an alternator, generator, hydraulic pump, or other type of heavy electrical power generating source on the implement. For example, according to at least some aspects and/or embodiments disclosed, the power includes a conversion from 12V to 24V with a DC to DC converter.

It is a further object, feature, and/or advantage of the invention to provide an agricultural system that supplies the requisite power to electronic components located on the row units wherein all electrical power supplied to the electronic components originates from a power source located on the agricultural vehicle.

It is a further object, feature, and/or advantage of the invention to provide an agricultural implement that performs a voltage conversion in order to supply the requisite power to electronic components located on the row units.

It is a further object, feature, and/or advantage of the invention to provide a user interface to allow a user to selectively enable and/or disable the voltage converter in order to supply the requisite power to electronic components located on the row units.

It is a further object, feature, and/or advantage of the invention to automatically enable and/or disable the voltage converter based on the voltage needs of the electronic components in order to supply the requisite power to the electronic components.

It is a further object, feature, and/or advantage of the invention to provide a method that supplies the appropriate power required by electrical components that are located on an agricultural planting implement and that are configured to perform at least one agricultural function.

It is a further object, feature, and/or advantage of the invention to provide a method that supplies the requisite power to electronic components located on the row units of the agricultural implement without including an alternator, generator, hydraulic pump, or other type of heavy electrical power generating source on the implement.

It is a further object, feature, and/or advantage of the invention to provide a method that supplies the requisite power to electronic components located on the row units wherein all electrical power supplied to the electronic components originates from a power source located on or otherwise associated with an agricultural vehicle.

It is a further object, feature, and/or advantage of the invention to provide a method that performs a voltage conversion in order to supply the requisite power to electronic components located on the row units of an agricultural implement.

It is a further object, feature, and/or advantage of the invention to provide a method to allow a user to selectively enable and/or disable the voltage converter in order to supply the requisite power to electronic components located on the row units.

It is a further object, feature, and/or advantage of the invention to provide a method to automatically enable and/or disable the voltage converter based on the voltage needs of the electronic components in order to supply the requisite power to the electronic components.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the invention.

Methods can be practiced which facilitate use, manufacture, assembly, maintenance, and repair of an agricultural planting implement which accomplish some or all of the previously stated objectives.

The agricultural planting implement can be incorporated into systems which accomplish some or all of the previously stated objectives.

According to some aspects of the present disclosure, an agricultural planting implement for use with an agricultural vehicle comprises a plurality of row units, and at least one DC to DC voltage converter that receives an input voltage and produces an output voltage wherein the output voltage is different than the input voltage, wherein the electronic planting implement comprises electronic components configured to perform at least one agricultural function and, when receiving a power supply, each electronic component is supplied a voltage equal to either the input voltage or the output voltage, and wherein all electrical power supplied to the electronic components originates from a power source located at the agricultural vehicle.

According to at least some aspects of the present disclosure, the agricultural planting implement comprises at least one harnessing assembly in operable communication with the converter to distribute power across the electronic components.

According to at least some aspects of the present disclosure, the agricultural planting implement comprises an integrated circuit in operable communication with the converter and a relay switch.

According to at least some aspects of the present disclosure, the relay switch is configured to close when the relay switch receives a signal from the integrated circuit, wherein when the relay switch is closed the electronic components will receive a voltage equal to the output voltage.

According to at least some aspects of the present disclosure, the agricultural planting implement comprises a user interface in operable communication with the integrated circuit and the converter wherein a user is able to provide user input.

According to at least some aspects of the present disclosure, the integrated circuit is configured to selectively enable or disable the converter based on the user input and to send a signal to the relay switch when the converter is enabled.

According to some additional aspects of the present disclosure, an agricultural planting implement for use with an agricultural vehicle comprises a plurality of row units comprising one or more electronic components configured to perform at least one agricultural function, at least one voltage converter that receives an input voltage and produces an output voltage wherein the output voltage is greater than the input voltage, at least one harnessing assembly in operable communication with the converter to distribute power across the plurality of row units, a relay switch configured to close when the relay switch receives a signal from an integrated circuit, wherein when the relay switch is closed the plurality of row units will receive a voltage equal to the output voltage, and a user interface in operable communication with an integrated circuit and the converter wherein a user is able to provide user input, wherein the integrated circuit is in operable communication with the converter and the relay switch, wherein the integrated circuit is configured to selectively enable or disable the converter based on the user input and to send a signal to the relay switch when the converter is enabled, wherein all electrical power supplied to the electronic components originates from a power source located on the agricultural vehicle.

According to at least some aspects of the present disclosure, the converter is a DC to DC converter.

According to at least some aspects of the present disclosure, the input voltage is 12 V and the output voltage is 24 V.

According to at least some aspects of the present disclosure, the required power supply for each electronic component is equal to either the input voltage or the output voltage.

According to at least some aspects of the present disclosure, the integrated circuit is further configured to monitor the output voltage and to verify the output voltage before communicating with the relay switch to close the relay switch.

According to at least some aspects of the present disclosure, the integrated circuit is further configured to monitor a voltage level that is output by the relay switch.

According to at least some aspects of the present disclosure, the user input can include a command to manually enable or disable the converter or a command to allow the converter to automatically enable or disable based on the voltage needs of the one or more electronic components.

According to at least some aspects of the present disclosure, the converter comprises at least one battery.

According to at least some aspects of the present disclosure, the battery pack comprises more than one battery connected in series to increase the voltage wherein each battery alone produces less voltage than the output voltage.

According to at least some aspects of the present disclosure, the converter comprises a first and second converter with a switch connecting the first and second converters so that one of the converters is producing the output voltage while the other converter is being charged by the input voltage.

According to at least some aspects of the present disclosure, the one or more electronic components comprise an electronic control unit, sensor, and/or a relay.

According to some additional aspects of the present disclosure, a method of supplying power to electronic components located on an agricultural planting implement wherein the agricultural planting implement is used with an agricultural vehicle comprises the steps of supplying an input voltage from the agricultural vehicle to a DC to DC voltage converter, converting the input voltage received by the converter to an output voltage produced by the converter wherein the output voltage is different than the input voltage, and distributing the output voltage to electronic components located on the agricultural planting implement, wherein all electrical power supplied to the electronic components originates from a power source located on the agricultural vehicle.

According to at least some aspects of the present disclosure, the converter is located on the agricultural planting implement.

According to at least some aspects of the present disclosure, the input voltage is 12 volts and the output voltage is 24 volts.

According to at least some aspects of the present disclosure, the method comprises selectively enabling or disabling the converter.

According to at least some aspects of the present disclosure, the method comprises sending a signal to a relay switch when the converter is enabled.

According to at least some aspects of the present disclosure, the method comprises closing the relay switch when the relay switch receives a signal, wherein when the relay switch is closed the electronic components will receive a power supply at a voltage equal to the output voltage.

According to some additional aspects of the present disclosure, a method of supplying power to electronic components located on an agricultural planting implement wherein the agricultural planting implement is used with an agricultural vehicle, comprises the steps of supplying an input voltage from the agricultural vehicle to a voltage converter located on the agricultural planting implement, allowing a user to provide user input, selectively enabling or disabling the converter based on the user input, converting the input voltage received by the converter to an output voltage produced by the converter when the converter is enabled, wherein the output voltage is different than the input voltage, sending a signal to a relay switch when the converter is enabled, closing the relay switch when the relay switch receives the signal, wherein when the relay switch is closed a plurality of row units on the agricultural planting implement will receive a power supply at a voltage equal to the output voltage, and distributing the output voltage to one or more electronic components located on the plurality of row units, wherein all electrical power supplied to the electronic components originates from a power source located on the agricultural vehicle.

According to at least some aspects of the present disclosure, the converter is a DC to DC converter.

According to at least some aspects of the present disclosure, the user input can include a command to manually enable or disable the converter or a command to allow the converter to automatically enable or disable based on the voltage needs of the one or more electronic components.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a view of an agricultural vehicle.

FIG. 2 is a view of an agricultural planting implement.

FIG. 3 is a block diagram of an agricultural vehicle attached to an agricultural planting implement according to one embodiment.

FIG. 4 is a block diagram of an agricultural planting implement according to an alternative embodiment.

FIG. 5 is a block diagram of a voltage converter according to one embodiment.

FIG. 6 is a schematic diagram of an agricultural vehicle attached to an agricultural planting implement according to one embodiment.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

Mechanical, electrical, chemical, procedural, and/or other changes apparent to one of ordinary skill in the art can be made without departing from the spirit and scope of the invention.

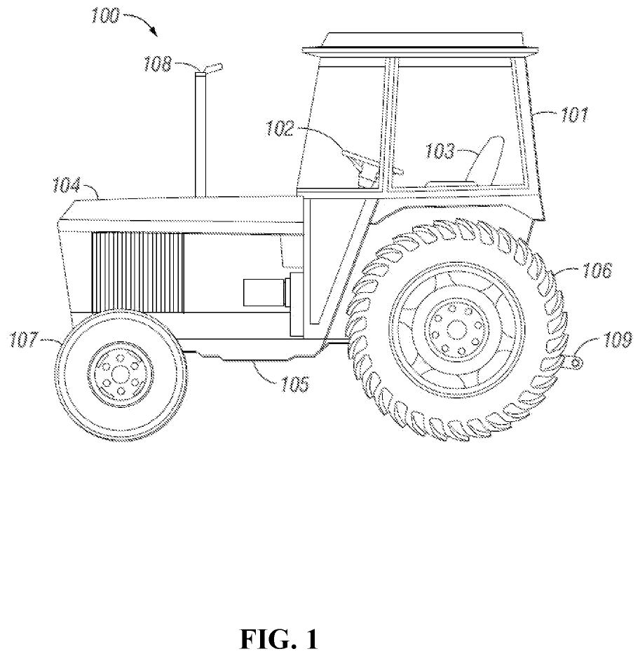

FIG. 1 shows an agricultural vehicle 100 (e.g., a tractor) used for the purposes of towing machinery used in agriculture (e.g., agricultural implements). Accordingly, the vehicle may be referred to as a prime mover, tow vehicle, or the like. The agricultural vehicle 100 may include a cab 101 with a steering wheel 102 and a seat 103 for an operator. The agricultural vehicle 100 may also include a vehicle frame 104 which houses an engine located near the front axle of the agricultural vehicle 100 and in front of the cab 101. The cab 101 and vehicle frame 104 may be supported, structurally, by the agricultural vehicle's chassis 105, which attaches to rear drivable wheels 106 and front steerable wheels 107, said front steerable wheels 107 operationally connected to the steering wheel 102. An exhaust pipe 108 allows carbon monoxide to exit the agricultural vehicle 100 during operation of the engine. A vehicle hitch 109 allows for connection between agricultural machinery, such as agricultural implements, and the agricultural vehicle 100.

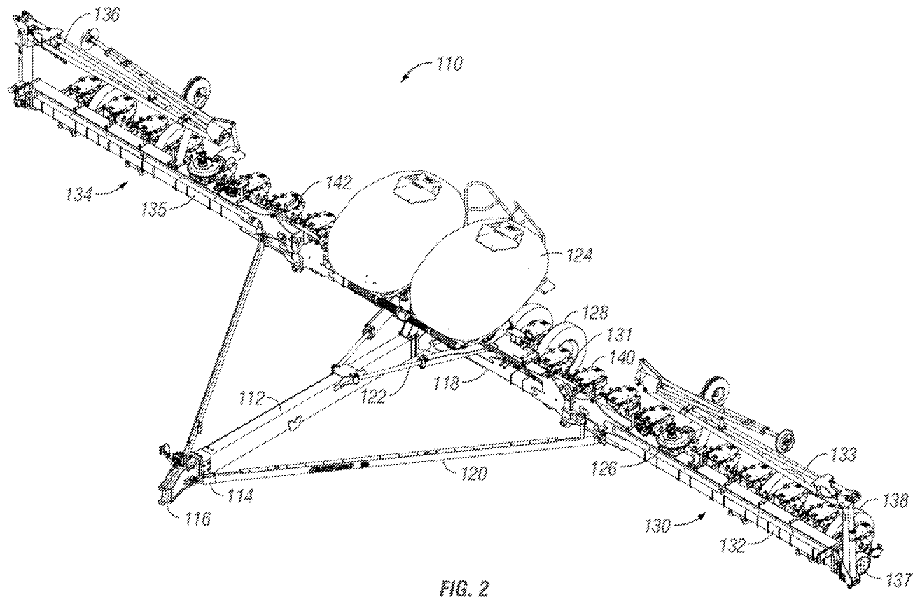

FIG. 2 shows an agricultural planting implement 110 used to plant and fertilize seed in a controlled manner. For example, the agricultural planting implement 110 as shown in FIG. 2 includes a tongue 112, which may be telescoping. The tongue 112 includes a first end 114 with an implement hitch 116 for attaching to a tow vehicle, such as the agricultural vehicle 100. The opposite end of the tongue 112 is attached to a frame or central toolbar 118. Draft links 120 are connected between the central toolbar 118 and the tongue 112 and are used in conjunction with folding actuators 122 to fold the central toolbar 118 in a frontward manner. Therefore, the tongue 112 may be a telescoping tongue in that it can extend or track to allow for the front folding of the central toolbar 118. The agricultural planting implement 110 may also be a lift and rotate, rear fold, vertical fold, narrow row, or generally any other type of planter.

The central toolbar 118 may include first and second wings 130, 134 extending therefrom. The central toolbar 118 may include central hoppers 124 which contain seed or other granules/particulate used with planting. A plurality of transport wheels 128 may also be connected to the central toolbar 118. The first and second wings 130, 134 are generally mere images of one another. The wings may include first and second wing toolbars 132, 135. Attached along the central toolbar 118 as well as the first and second wing toolbar 132, 135, are a plurality of row units 140. The row units include seed meters 142, ground engaging tools, and/or other electronic components 150 used for planting, tilling, and fertilizing seed in a controlled manner. The electronic components 150 may be sensors, sprayers, dispensers, fertilizers, valves, motors, actuators, fans, planting equipment, electronic control units, and the like. Also connected to the first and second wings 130, 134 are first and second markers 133, 136. The markers may include actuators 137 which are used to raise and lower the markers 133, 136. The markers 133, 136 can be lowered to provide guidance for the edge of a planter for use in planting. When not required, the markers 133, 136 can be lifted to a position as that shown in FIG. 2 to move the markers 133, 136 out of the way.

Also shown in FIG. 2 are a plurality of fans 126 as well as a plurality of wheels 138. The wings may also include actuators 131 to raise and lower or otherwise provide a downward force on the wings. Therefore, as is shown in FIG. 2, there are a multiplicity of components of the agricultural planting implement 110. The components may include moving parts, such as the actuators used to move the wings, markers, row units, etc., while also providing additional functions. For example, the fans 126 are used to provide a pressure in the seed meters 142 to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 140. Lights may also be included as part of the planter.

Additionally, an air seed delivery system may be provided between the central hoppers 124 and any plurality of seed meters 142 on the row units 140 in that the air seed delivery system provides a continued flow of seed to the row units on an as needed manner to allow for the continuous planting of the seed via the seed meters on the row units. Thus, the various controls of the planter may require or otherwise be aided by the use of an implement control system. The implement control system can aid in controlling each of the functions of the implement or agricultural planting implement 110 so as to allow for the seamless or near seamless operation with the implement, and also provides for the communication and/or transmission of data, status, and other information between the components.

As will be appreciated, the agricultural planting implement 110 need not include all of the features disclosed herein and may also include additional or alternative features as those shown and/or described. The foregoing has been included as an exemplary agricultural planting implement 110, and it should be appreciated that generally any agricultural planting implement from any manufacturer and any add-ons or aftermarket components may be included in any agricultural planting implement that encompasses any of the aspects of the invention. In addition, it should be appreciated that the implement 110 could be generally any type of agricultural implement and need not be used solely for planting. The implement 110 could be used to apply, plant, or otherwise distribute any type of liquid or dry material, such as particulate material.

Therefore, an agricultural planting implement 110 such as that shown, can be pulled by a tow vehicle, such as the agricultural vehicle 100 of FIG. 1. In addition, the agricultural planting implement 110 could be pulled by a self-propelled, autonomous tug unit, rather than an operator-driven vehicle, such as the agricultural vehicle 100, such as the one shown and described in co-owned U.S. Pat. No. 10,575,453, which is herein incorporated by reference in its entirety. The rear drivable wheels and front steerable wheels can be substituted for tracks, regardless of whether said tracks are implemented on an operator-driven vehicle or a self-propelled vehicle.

As noted, many agricultural implements, such as that shown in the figures, includes a number of electrically powered components. The different types of electronic components included as part of the row units of agricultural implements is ever increasing. Consequently, some electronic components included on row units of agricultural implements require different voltage levels in terms of power supply. This has created issues in the agricultural space in terms of how to provide differing power supplies to different electronic components located on an agricultural implement. As will be understood, aspects and/or embodiments of the invention provide for solutions to overcome said challenges. These solutions can include providing for all of the electrical power supplied to the electronic components located on the agricultural implement to originate from a power source located on or otherwise associated with an agricultural vehicle towing the agricultural implement. In this manner, a generator, alternator, or something of the like is not needed to be included on the agricultural implement to generate electrical energy. These solutions may also include the use of a voltage converter located on an agricultural implement or positioned between the tow vehicle and the implement to selectively convert the voltage level of a power supply in order to meet the voltage requirements of electronic components included on the agricultural implement.

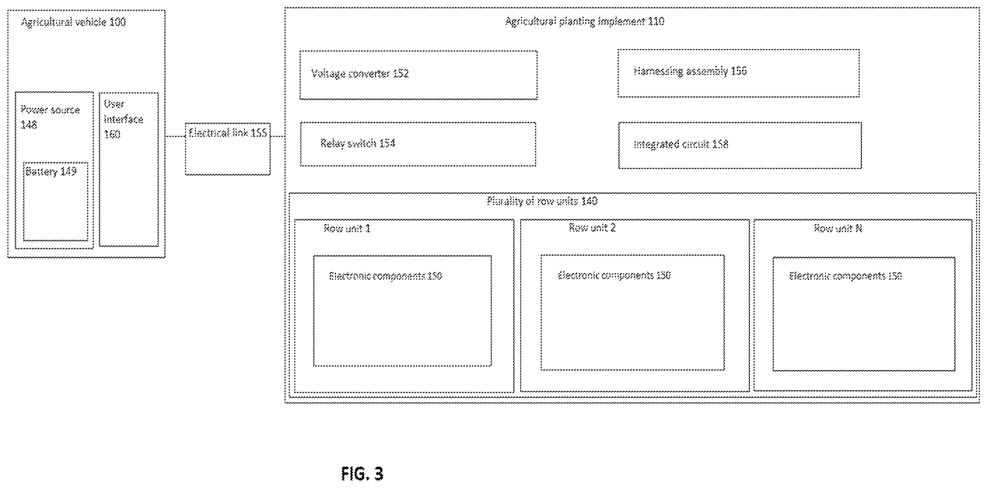

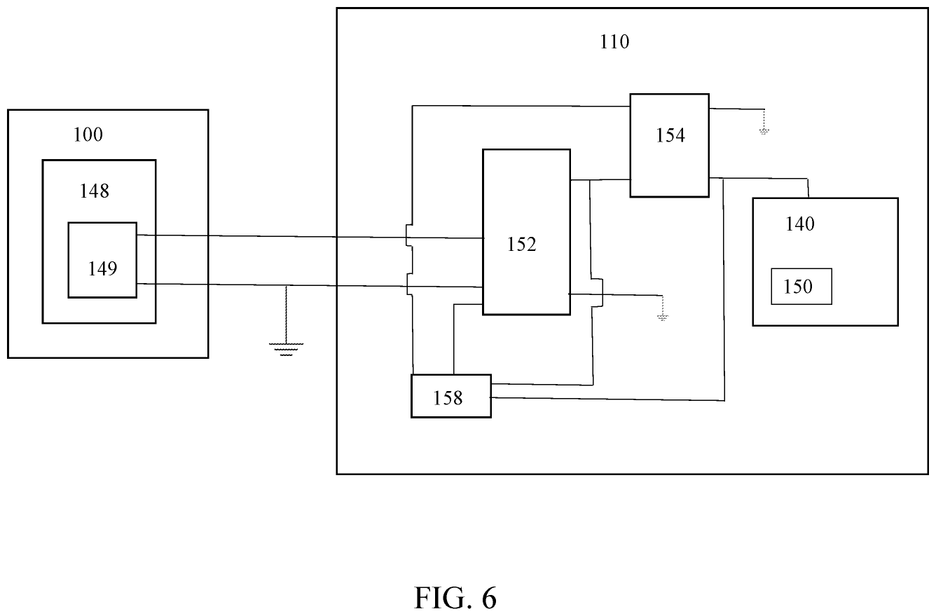

FIG. 3 is a block diagram that shows an agricultural planting implement 110 attached to an agricultural vehicle 100 according to aspects of the present disclosure. FIG. 6 is an electrical schematic that shows the embodiment depicted in FIG. 3. As shown in FIGS. 3 and 6, some components of the invention may not be included on the agricultural planting implement 110 itself. For example, FIGS. 3 and 6 show that the power source 148 is located on the agricultural vehicle 100. For example, the power source may be an outlet of the agricultural vehicle 100. All electrical power supplied to the electronic components originates from the power source 148 located on the agricultural vehicle 100. In other words, while the voltage converter 152 may increase or step up the voltage supplied by the power source 148, no electrical power needs to be generated on the agricultural planting implement 110 via the use of a generator, alternator, hydraulic pump, or some other heavy electrical power generation means. FIGS. 3 and 6 show that the power source 148 may comprise a battery 149. The battery 149 may comprise one or more batteries. The battery 149 may be a battery housed within the agricultural vehicle's 100 engine. Other configurations of the power source 148 are possible. For example, the battery 149 could be replaced with or supplemented by an alternator located on the agricultural vehicle 100. In other words, the power source 148 could comprise a battery 149 and/or an alternator located on the agricultural vehicle 100. The power source 148 could supply the total voltage from a battery 149 and/or the excitation voltage from an alternator located on the agricultural vehicle 100. The power source 148 outputs a particular voltage to a device or component or components of a device. The power source 148 could be a direct current (“DC”) power supply (e.g., a battery), an alternating current (“AC”) power supply, a linear regulator, etc. The power source 148 can be configured with a microcontroller to receive power from other grid-independent power sources, such as a generator or solar panel.

With respect to the battery 149, a dry cell battery may be used. Additionally, the battery may be rechargeable, such as a lead-acid battery, a low self-discharge nickel metal hydride battery (“LSD-NiMH”) battery, a nickel—cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power source 148 could also be driven by a power generating system, such as a dynamo using a commutator or through electromagnetic induction. Electromagnetic induction eliminates the need for batteries or dynamo systems but requires a magnet to be placed on a moving component of the system.

The power source 148 may also include an emergency stop feature, also known as a “kill switch,” to shut off the machinery in an emergency. The power source 148 may also include any other safety mechanisms known to prevent injury to users of the machine. The emergency stop feature or other safety mechanisms may need user input or may use automatic sensors to detect and determine when to take a specific course of action for safety purposes.

FIG. 3 also show that a user interface 160 is located on the agricultural vehicle 110. A user may offer input via the user interface 160. While the user interface 160 is located on the agricultural vehicle 100 in FIG. 3, alternatively the user interface 160 could be located on the agricultural planting implement 110. In other embodiments, the user interface 160 may not be physically attached to either the agricultural vehicle 100 or agricultural planting implement 110. In those embodiments, a user may access the user interface 160 remotely via a hand-held device such as a smart phone, tablet, laptop, and/or other computing devices.

The user interface 160 can be a digital interface, a command-line interface, a graphical user interface (“GUI”), oral interface, virtual reality interface, or any other way a user can interact with a machine (user-machine interface). For example, the user interface 160 (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface 160 can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface 160 also can be configured with a microcontroller and/or an integrated circuit to display conditions or data associated with the main device in real-time or substantially real-time as well as allow a user to provide input.

Additionally, while not shown, it is appreciated that the user interface may include a processor, non-transitory computer readable medium, modules/programs, memory, operating system, database, power, communications/networks, and/or a number of inputs and/or inputs.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The user interface 160 may include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the invention. A software application, operating instructions, and/or firmware (semi-permanent software programmed into read-only memory) may also be tangibly embodied in the memory and/or data communication devices, thereby making the software application a product or article of manufacture according to the invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

FIG. 3 further shows an electrical link 155 between the agricultural vehicle 100 and the agricultural planting implement 110. The electrical link 155 may provide several functions for the invention. For example, the electrical link 155 provides the ability for power, such as electrical power, to be exchanged between the agricultural vehicle 100 and the agricultural planting implement 110. Thus, power may be supplied from the agricultural vehicle 100 to the agricultural planting implement 110. The electrical link 155 also allows for data communication between the agricultural vehicle 100 and the agricultural planting implement 110, such as via Ethernet or like connection. Thus, the user interface 160 may be able to communicate with components on the agricultural planting implement 110 and vice versa. For data communication, the electrical link 155 may be a physical link (e.g., cord and/or wire). In other embodiments, the electrical link used for data communication may involve communicating data over a wireless network. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Other embodiments may employ the use of ethernet communication. Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

Still other embodiments may employ the use of ISOBUS communication. ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CANbus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

FIGS. 3 and 6 also show a voltage converter 152 located on the agricultural planting implement 110. The voltage converter 152 takes in, accepts, or receives an input voltage from the power source 148 and produces an output voltage in which the output voltage is different than the input voltage. The voltage converter 152 may be a voltage step-up converter in which the output voltage is greater than the input voltage. According to some aspects of some embodiments, the voltage converter 152 receives an input voltage of 12 V and produces an output voltage of 24 V. However, other types of voltage conversion with varying voltage levels are possible in other embodiments. The output of the voltage converter 152 may be rated to 1000 watts. However, other wattages are possible. The voltage converter 152 can perform DC to DC voltage conversion, AC to DC voltage conversion, DC to AC voltage conversion, and/or AC to AC voltage conversion. Still further, while the voltage converter 152 is shown on the implement, it should be appreciated that it could be located at the vehicle, or between the vehicle and the implement, such as part of the electrical link.

The voltage converter 152 is in operable communication with an integrated circuit 158 and a relay switch 154. The integrated circuit 158 can selectively enable and/or disable the voltage converter 152. The enabling and/or disabling may be based on user input. A user may provide user input via the user interface 160. When the voltage converter 152 is enabled, the voltage converter 152 performs a voltage conversion in which the output voltage produced by the voltage converter 152 is different than the input voltage received by the voltage converter 152. When the voltage converter 152 is disabled, the voltage converter does not perform a voltage conversion. Due to the ability of the voltage converter 152 to be selectively enabled and disabled, the voltage converter can provide different power supplies having differing voltage levels to various electronic components 150 located on the implement, including the plurality of row units 140. Therefore, when different electronic components 150 that have different power needs in terms of voltage level exist on the same agricultural implement, all of the electronic components may be powered by a single power source, such as via the agricultural vehicle. For example, the power source 148 located on the agricultural vehicle 100 that is configured to tow the agricultural planting implement 110 may provide a 12 V power supply/output. If there are electronic components 150 wherein some of the components require a 12 V power supply and some require a 24 V power supply, the voltage converter 152 can be selectively enabled and/or disabled to provide the required power supply to each electronic component. In this example, the voltage converter 152 can be disabled, so that no voltage conversion occurs, when supplying power to the electronic components 150 that require a 12 V power supply. Therefore, no voltage conversion occurs on the 12 V power supply provided by the power source 148, and the electronic components 150 that require a 12 V power supply receive a 12 V power supply. In this same example, when supplying power to the electronic components 150 that require a 24 V power supply, the voltage converter 152 would be enabled. Thus, the 12 V power supply provided by the power source 148 would be converted to a 24 V power supply by the voltage converter 152, and the electronic components 150 that require a 24 V power supply will receive a 24 V power supply.

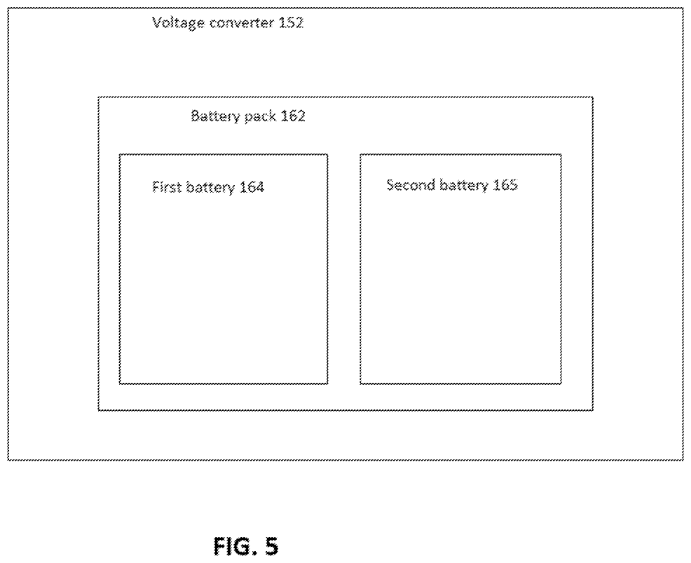

Although the voltage converter 152 may take many forms, in an embodiment of the voltage converter 152, the voltage converter 152 may comprise a battery pack 162, as can be seen in FIG. 5. In other embodiments a voltage converter 152 may comprise a plurality of battery packs 162 that may number from one to N, where N can be any number greater than one. In other embodiments the voltage converter 152 may be any standard, off-the-shelf voltage converter product.

A battery pack 162 may comprise a first battery 164 and a second battery 165, as can be seen in FIG. 5, although any number of batteries could be used. The first battery 164 and second battery 165 may be connected in series to increase the voltage wherein each battery alone produces less voltage than the output voltage produced by the voltage converter 152. For example, each battery may produce a 12 V charge, but when connected in series they may together produce a 24 V charge. In other embodiments, batteries other than 12 V batteries may be connected in series to produce a charge other than 24 V. This also includes generally any number of batteries required.

Still further, when less than 24 V are needed, the battery packs can be placed in parallel, which will allow for longer use of the batteries.

With respect to the first and second batteries 164, 165, a dry cell battery may be used. Additionally, the battery may be rechargeable, such as a lead-acid battery, a low self-discharge nickel metal hydride battery (“LSD-NiMH”) battery, a nickel—cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

FIG. 3 also shows a harnessing assembly 156 located on the agricultural planting implement 110. The harnessing assembly 156 is in operable communication with the voltage converter 152 and electronic components 150 located on a plurality of row units 140. The harnessing assembly 156 can be any type of assembly of cables or wires used to transport electric energy and/or power. The harnessing assembly 156 works to distribute power across the agricultural planting implement 110 and to the electronic components. The voltage converter 152 can be plugged into the harnessing assembly 156. The voltage converter 152 may be connected to the harnessing assembly 156 using a remote control device.

FIGS. 3 and 6 also show a relay switch 154 located on the agricultural planting implement 110. The relay switch 154 may include one or more relay switches. In some embodiments the relay switch 154 is a 24 V relay switch, but other voltage levels could be used. The relay switch 154 is in operable communication with a voltage converter 152, an integrated circuit 158, and electronic components 150 located on a plurality of row units 140. The relay switch 154 is configured to close when the relay switch 154 receives a voltage equal to the output voltage produced by the voltage converter 152. In some embodiments this output voltage is equal to 24 V, however, the output voltage may differ in other embodiments. The relay switch 154 may be configured to close automatically upon receiving a voltage equal to that of the output voltage of the voltage converter 152. In other embodiments the relay switch 154 may be configured to close upon receiving a signal, electronic or otherwise, from the integrated circuit 158. The relay switch 154 can also be configured to open upon receiving a signal from the integrated circuit 158. When the relay switch 154 is closed the circuit connecting the voltage converter 152 and integrated circuit 158 to the electronic components 150 is complete and power will be supplied to the electronic components 150 at a voltage level equal to that of the output voltage produced by the voltage converter 152. Thus, when the relay switch 154 is closed the plurality of row units 140 will receive a voltage substantially equal to the output voltage produced by the voltage converter 152.

FIGS. 3 and 6 also show an integrated circuit 158 located on the agricultural planting implement 110. The integrated circuit 158 is in operable communication with a voltage converter 152, relay switch 154, and user interface 160. The integrated circuit 158 is able to accept, interpret, and act on user input that a user offers via the user interface 160. For example, a user may manually enable or disable the voltage converter 152 via the user interface 160. When a user enables the voltage converter 152 via the user interface 160, the integrated circuit 158 communicates with the relay switch 154 to close the relay switch 154. This communication may be accomplished by providing a voltage level to the relay switch 154 that is equal to that of the output voltage produced by the voltage converter 152. This would cause the relay switch 154 to close in order to provide power to the electronic components 150 at a voltage level equal to that of the output voltage produced by the voltage converter 152. Also, when a user enables the voltage converter 152 via the user interface 160, the integrated circuit 158 may send a signal, electronic or otherwise, to the relay switch 154 to cause the relay switch 154 to close in order to provide power to the electronic components 150 at a voltage level equal to that of the output voltage produced by the voltage converter 152. When a user disables the voltage converter 152 via the user interface 160, the integrated circuit 158 communicates with the relay switch 154 to open the relay switch 154. This communication may be accomplished by providing a voltage level to the relay switch 154 that is different than the output voltage produced by the voltage converter 152. This would cause the relay switch 154 to open in order to prevent power from being supplied to the electronic components 150 at a voltage level equal to that of the output voltage produced by the voltage converter 152. Also, when a user disables the voltage converter 152 via the user interface 160, the integrated circuit 158 may send a signal, electronic or otherwise, to the relay switch 154 to cause the relay switch 154 to open in order to prevent power to be supplied to the electronic components 150 at a voltage level equal to that of the output voltage produced by the voltage converter 152. When a user enables the voltage converter 152 via the user interface 160, the integrated circuit 158 may send a signal, electronic or otherwise, to the voltage converter 152 to enable the voltage converter 152. When a user disables the voltage converter 152 via the user interface 160, the integrated circuit 158 may send a signal, electronic or otherwise, to the voltage converter to disable the voltage converter 152. The integrated circuit 158 is configured to selectively enable or disable the voltage converter 152 based on the user input. This can be a user manually enabling or disabling the voltage converter 152 or this can be done by automatically enabling or disabling the voltage converter 152 based on the needs of the electronic components 150. For example, if some electronic components 150 require a 12 V power supply and others require a 24 V power supply, the integrated circuit 158 may disable the voltage converter 152 when supplying power to the electronic components 150 that require 12 V (assuming the input voltage received by the voltage converter 152 is 12 V) and enable the voltage converter 152 to perform a step up conversion when supplying power to the electronic components 150 that require 24 V (assuming the output voltage produced by the voltage converter 152 is 24 V).

Additionally, the integrated circuit 158 may be configured to monitor the output voltage produced by the voltage converter 152 and to verify said output voltage before communicating with the relay switch 154 to close the relay switch 154. The integrated circuit 158 may also be configured to monitor and verify the output current of the output produced by the voltage converter 152 before communicating with the relay switch 154 to close the relay switch 154.

In this way, the integrated circuit 158 monitors the power output by the voltage converter 152 as a function of voltage and current. The integrated circuit 158 may also be configured to monitor the voltage level and current level that is output by the relay switch 154. While the integrated circuit 158 may manually enable and disable the voltage converter 152 based on user input, the integrated circuit 158 may also allow the voltage converter 152 to automatically enable or disable based on the voltage needs of the electronic components 150. A user may provide input to allow the voltage converter 152 to automatically enable or disable based on the voltage needs of the electronic components 150. The integrated circuit 158 may also allow the voltage converter 152 to be automatically enabled or disabled based on the output of the voltage converter 152.

FIGS. 3 and 6 also show a plurality of row units 140 located on the agricultural planting implement 110. The row units 140 may number from one to N, where N can be any number greater than one. Power is distributed to the plurality of row units 140 via a harnessing assembly 156. Further, the row units 140 may include seed meters 142, ground engaging tools, and/or other electronic components 150 used for planting, tilling, and fertilizing seed in a controlled manner. The electronic components 150 may be any kind of electronic component configured to perform an agricultural function such as, but not limited to, sensors, sprayers, dispensers, fertilizers, valves, motors, planting equipment, electronic control units, meters, fans, controllers, and the like. Regarding the plurality of row units 140, each row unit may comprise electronic components 150 configured to perform an agricultural function.

FIG. 3 also shows electronic components 150 configured to perform at least one agricultural function located on each row unit. The electronic components 150 located on each row unit may number from one to N, where N can be any number greater than one. The row units 140 may include seed meters 142, ground engaging tools, and/or other electronic components 150 used for planting, tilling, and fertilizing seed in a controlled manner. Further, the electronic components 150 may be any kind of electronic component configured to perform an agricultural function such as, but not limited to, sensors, sprayers, dispensers, fertilizers, valves, motors, planting equipment, electronic control units, and the like.

The electronic components 150 are in operable communication with the voltage converter 152, integrated circuit 158, and relay switch 154, in order to receive power at the proper voltage level. Some electronic components 150 may require a different voltage level than other electronic components 150. For example, while some electronic components 150 may require a 12 V power supply, others may require a 24 V power supply. The previous was simply an example of differing power supply requirements and does not limit the invention to only supporting the exemplary voltage levels. Voltage levels other than 12 V or 24 V may be required by some electronic components 150. The electronic components 150 may be configured to receive power at a voltage level equal to either the input voltage supplied to the voltage converter 152 or the output voltage produced by the voltage converter 152. The voltage level received by the electronic components 150 will depend on whether the voltage converter 152 is enabled or disabled and whether the relay switch 154 is closed or open. A user may manually enable or disable the voltage converter 152. When a user manually enables the voltage converter 152, the electronic components 150 will receive power at a voltage level equal to the output voltage produced by the voltage converter 152. When a user manually disables the voltage converter 152, the electronic components 150 will receive power at a voltage level equal to the input voltage received by the voltage converter 152 because the voltage converter 152 will not perform a voltage conversion. This may be the same voltage level as that supplied by the power source 148. Additionally, aspects of the invention allows for the voltage converter 152 to automatically be enabled or disabled based on the requirements of the electronic components 150. For example, if power is being supplied to electronic components 150 that require 24 V and the voltage converter 152 produces an output voltage of 24 V, the voltage converter 152 will be enabled. If power is supplied to electronic components 150 that require 12 V and the input voltage received by the voltage converter 152 is 12 V, the voltage converter 152 will be disabled.

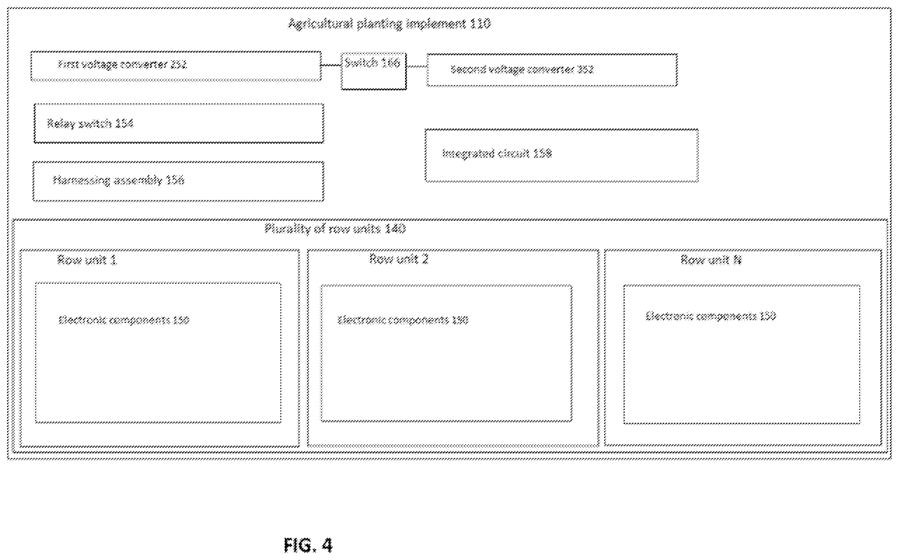

FIG. 4 shows another embodiment of an agricultural planting implement 110 that includes two voltage converters, a first voltage converter 252 and a second voltage converter 352 connected by a switch 166. Although only two voltage converters are shown in FIG. 4, the voltage converters may number from one to N, where N can be any number greater than one. In an embodiment that uses a first voltage converter 252 and a second voltage converter 352, such as in the form of battery packs, power supplied by the agricultural vehicle 100 may be used to charge the first voltage converter 252 while the second voltage converter 352 is performing a voltage conversion on the input voltage received by the second voltage converter 352 to produce an output voltage that is different than the input voltage. The opposite may occur in which the first voltage converter 252 may be performing a voltage conversion while the second voltage converter 352 is being charged. Whichever voltage converter, either the first 252 or the second 352, is performing the voltage conversion and producing an output voltage different than the input voltage that it receives, will be in operable communication with the electronic components 150. The electronic components 150 will be powered by the output voltage produced by either the first or second voltage converters 252, 352.

FIG. 4 also shows a switch 166 connecting a first voltage converter 252 and a second voltage converter 352. The switch 166 can act as an on/off switch wherein power supplied by the agricultural vehicle 100 may be used to charge the first voltage converter 252 while the second voltage converter 352 is performing a voltage conversion on the input voltage received by the second voltage converter 352 to produce an output voltage that is different than the input voltage. The opposite may occur in which the first voltage converter 252 may be performing a voltage conversion while the second voltage converter 352 is being charged. The switch 166 can be used to toggle which voltage converter is performing a voltage conversion and powering the electronic components 150 and which is being charged. Also, it is possible for both the first and second voltage converters 252, 352 to be powering electronic components 150 at the same time. Also, it is possible both the first and second voltage converters 252, 352 may be charging at the same time.

FIG. 5 shows an embodiment of a voltage converter 152. A voltage converter 152 may comprise a battery pack 162. In other embodiments a voltage converter 152 may comprise a plurality of battery packs 162 that may number from one to N, where N can be any number greater than one.

A battery pack may comprise a first battery 164 and a second battery 165. The first battery 164 and second battery 165 may be connected in series to increase the voltage wherein each battery alone produces less voltage than the output voltage. For example, each battery may produce a 12 V charge, but when connected in series they may together produce a 24 V charge. In other embodiments batteries other than 12 V batteries may be connected in series to produce a charge other than 24 V.

With respect to the first and second batteries 164, 165, a dry cell battery may be used. Additionally, the battery may be rechargeable, such as a lead-acid battery, a low self-discharge nickel metal hydride battery (“LSD-NiMH”) battery, a nickel—cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

As noted, the batteries, or packs of batteries could be used in conjunction with additional batteries and/or battery packs. For example, another battery pack similar to that shown in FIG. 5 can be included. One battery pack can be used to provide the desired output, while the other or another battery pack is being charged via the agricultural vehicle. The system can be closed in which it automatically switches upon detection of a threshold level of one or both of the packs. In addition, a user can be monitoring the levels of charge of the battery packs and can selectively switch, as needed, between the packs. Either situation can make sure desired output levels are obtained and maintained during operation of the implement.

FIG. 6 shows a schematic diagram of an agricultural vehicle 100 attached to an agricultural planting implement 110. FIG. 6 is an electrical schematic diagram of the embodiment shown in FIG. 3. Schematically, FIG. 6 shows a power source 148 located on the agricultural vehicle 100 wherein the power source 148 may comprise a battery 149. In other embodiments the power source 148 may comprise a battery or batteries 149, which can be replaced or supplemented by an alternator located on the agricultural vehicle 100. The power source/battery 148/149 is electrically connected to a voltage converter 152 located on the agricultural planting implement 110. One of the connections shown between the battery 149 and the voltage converter 152 includes a connection to ground. Additionally, the voltage converter 152 may or may not be electrically isolated.

In addition to the voltage converter 152, FIG. 6 also shows that the agricultural planting implement 110 also includes an integrated circuit 158, a relay switch 154, a plurality of row units 140, and electronic components 150 configured to perform at least one agricultural function located on the plurality of row units 140. The integrated circuit 158 is electrically connected to the voltage converter 152 and a relay switch 154. The electric connection between the integrated circuit 158 and the voltage converter 152 allows the integrated circuit to selectively enable and/or disable the voltage converter 152 wherein the selective enabling or disabling may be based on user input. The integrated circuit 158 is also electrically connected to the relay switch 154 in order to provide a voltage level and/or send a signal to the relay switch to cause the relay switch 154 to open or close. The integrated circuit 158 is also in electrical connection with the output of the voltage converter 152 in order to sense, monitor, and verify the voltage level of the output voltage produced by the voltage converter 152. In addition to monitoring the voltage level of the output of the voltage converter 152, the integrated circuit 158 also monitors the current of the output of voltage converter 152. In this way, the integrated circuit 158 monitors the power output by the voltage converter 152 as a function of voltage and current. The output of the voltage converter 152 may be resistive power. The current and voltage of the output of the voltage converter 152, which may be monitored by the integrated circuit 158, may be analog or digital outputs. The integrated circuit 158 verifies that the current and voltage of the output of the voltage converter 152 is at a desired level before providing a voltage level and/or sending a signal to the relay switch 154 to cause the relay switch 154 to close. The integrated circuit 158 is also electrically connected to the output of the relay switch 154 to sense and monitor the voltage and current levels of the output of the relay switch 154. The inputs and outputs of the integrated circuit 158 may be made up of any combination of analog and/or digital inputs and outputs.

The voltage converter 152 is able to produce several fault outputs that can be received by the integrated circuit 158. These fault outputs may be analog or digital outputs. Examples of fault outputs that can be produced by the voltage converter 152 include: a short-circuit fault, an open-circuit fault, an over-voltage fault, and an over-current fault. As explained above, the integrated circuit 158 monitors the output of the voltage converter 152 and can receive and interpret signals produced by the voltage converter 152. Thus, by monitoring the output of the voltage converter 152, the integrated circuit 158 can sense potential issues, such as irregular voltage or current or a fault output, prior to enabling/closing the relay switch 154 and providing a converted voltage produced by the voltage converter 152 to the electronic components 150. Thus, the integrated circuit 158 can verify that the output of the voltage converter 152 has proper voltage and current and that no fault outputs are present before enabling/closing the relay switch 154 such that a converted voltage produced by the voltage converter 152 is supplied to the electronic components 150. If the integrated circuit 158 determines that the output of the voltage converter 152 is satisfactory, the integrated circuit 158 can enable the voltage converter 152 and/or enable/close the relay switch 154 to supply a converted voltage produced by the voltage converter 152 to the electronic components 150. By monitoring and verifying that no issues exist regarding the output of the voltage converter 152 before supplying the voltage converter's 152 output to the electronic components 150, any components, whether it be electronic components 150 or otherwise, located on the agricultural planting implement 110 that might fail as a result of supplying the output of the voltage converter 152 when it is in a failed state will be preserved. The integrated circuit 158 can continue to monitor the output of the voltage converter 152 during operation of the agricultural planting implement 110. While monitoring the output of the voltage converter 152, if the integrated circuit 158 senses any issues, such as irregular voltage or current or a fault output, the integrated circuit 158 may automatically disable the voltage converter 152 and/or open the relay switch 154 so that a converted voltage is not provided to the electronic components 150. Additionally, if the integrated circuit 158 senses any issues with the output of the voltage converter 152, the integrated circuit may produce an alarm.

The integrated circuit 158 is also operatively connected to the power source 148 on the agricultural vehicle 100. The integrated circuit 158 can monitor the voltage level of the power source 148 and verify that it is sufficient. After the agricultural vehicle has been powered ON via a key switch or other means, the integrated circuit 158 can power ON and then verify the voltage level of the power source 148 is sufficient. Power supplied to the voltage converter 152 will originate from the power supply 148 located on the agricultural vehicle 100 when the agricultural vehicle 100 is powered ON via key switch or other means.

The voltage converter 152 is electrically connected to the relay switch 154 in order to provide an output voltage produced by the voltage converter 152 to the relay switch 154. The voltage converter 152 is also electrically connected to an isolated ground.

The relay switch 154 is electrically connected to the plurality of row units 140 and the electronic components 150 that are configured to perform at least one agricultural function, which are located on the plurality of row units. The relay switch 154 is also electrically connected to ground. When the relay switch 154 is closed and the voltage converter 152 is enabled, the electronic components 150 will receive a power supply at a voltage level equal to that of the output voltage produced by the voltage converter 152.

From the foregoing, it can be seen that the embodiments and/or aspects disclosed accomplish at least all of the stated objectives. The present disclosure is not to be limited to the particular embodiments described herein. In addition, it should be appreciated that any of the aspects disclosed relative to any of the embodiments shown and/or described could be combined with any of the other aspects and/or embodiments to provide even additional embodiments that those disclosed herein. Such additional embodiments would be obvious to those skilled in the art.

1. An agricultural planting implement for use with an agricultural vehicle, comprising:
a plurality of row units; and
at least one DC to DC voltage converter that receives an input voltage and produces an output voltage wherein the output voltage is different than the input voltage;
wherein the agricultural planting implement comprises electronic components configured to perform at least one agricultural function and, when receiving a power supply, each electronic component is supplied a voltage equal to either the input voltage or the output voltage; and
wherein all electrical power supplied to the electronic components originates from a power source located at the agricultural vehicle.

2. The agricultural implement of claim 1, further comprising at least one harnessing assembly in operable communication with the converter to distribute power across the electronic components.

3. The agricultural planting implement of claim 1, further comprising an integrated circuit in operable communication with the converter and a relay switch.

4. The agricultural implement of claim 3, wherein the relay switch is configured to close when the relay switch receives a signal from the integrated circuit, wherein when the relay switch is closed the electronic components will receive a voltage equal to the output voltage.

5. The agricultural planting implement of claim 4, further comprising a user interface in operable communication with the integrated circuit and the converter wherein a user is able to provide user input.

6. The agricultural planting implement of claim 5, wherein the integrated circuit is configured to selectively enable or disable the converter based on the user input and to send a signal to the relay switch when the converter is enabled.

7. An agricultural planting implement for use with an agricultural vehicle, comprising:
a plurality of row units comprising one or more electronic components configured to perform at least one agricultural function;
at least one voltage converter that receives an input voltage and produces an output voltage wherein the output voltage is greater than the input voltage;
at least one harnessing assembly in operable communication with the converter to distribute power across the plurality of row units;
a relay switch configured to close when the relay switch receives a signal from an integrated circuit, wherein when the relay switch is closed the plurality of row units will receive a voltage equal to the output voltage; and
a user interface in operable communication with an integrated circuit and the converter wherein a user is able to provide user input;
wherein the integrated circuit is in operable communication with the converter and the relay switch;
wherein the integrated circuit is configured to selectively enable or disable the converter based on the user input and to send a signal to the relay switch when the converter is enabled;
wherein all electrical power supplied to the electronic components originates from a power source located on the agricultural vehicle.

8. The agricultural implement of claim 7, wherein the converter is a DC to DC converter.

9. The agricultural implement of claim 8, wherein the input voltage is 12 V and the output voltage is 24 V.

10. The agricultural planter of claim 7, wherein the required power supply for each electronic component is equal to either the input voltage or the output voltage.

11. The agricultural planting implement of claim 10, wherein the voltage supplied to the one or more electronic components is equal to either the input voltage or the output voltage.

12. The agricultural planting implement of claim 7, wherein the integrated circuit is further configured to monitor the output voltage and to verify the output voltage before communicating with the relay switch to close the relay switch.

13. The agricultural planting implement of claim 12, wherein the integrated circuit is further configured to monitor a voltage level that is output by the relay switch.

14. The agricultural planting implement of claim 11, wherein the user input can include a command to manually enable or disable the converter or a command to allow the converter to automatically enable or disable based on the voltage needs of the one or more electronic components.

15. The agricultural planting implement of claim 7, wherein the converter comprises at least one battery pack.

16. The agricultural planting implement of claim 15, wherein the battery pack comprises more than one battery connected in series to increase the voltage wherein each battery alone produces less voltage than the output voltage.

17. The agricultural planting implement of claim 16, wherein the converter comprises a first and second converter with a switch connecting the first and second converters so that one of the converters is producing the output voltage while the other converter is being charged by the input voltage.

18. The agricultural planting implement of claim 7, wherein the one or more electronic components comprise an electronic control unit, sensor, and/or a relay.

19. A method of supplying power to electronic components located on an agricultural planting implement wherein the agricultural planting implement is used with an agricultural vehicle, comprising the steps of:
supplying an input voltage from the agricultural vehicle to a DC to DC voltage converter;
converting the input voltage received by the converter to an output voltage produced by the converter wherein the output voltage is different than the input voltage; and
distributing the output voltage to electronic components located on the agricultural planting implement;
wherein all electrical power supplied to the electronic components originates from a power source located on the agricultural vehicle.

20. The method of claim 19, wherein the converter is located on the agricultural planting implement.

21. The method of claim 19, wherein the input voltage is 12 volts and the output voltage is 24 volts.

22. The method of claim 19, further comprising selectively enabling or disabling the converter.

23. The method of claim 22, further comprising sending a signal to a relay switch when the converter is enabled.

24. The method of claim 23, further comprising closing the relay switch when the relay switch receives a signal, wherein when the relay switch is closed the electronic components will receive a power supply at a voltage equal to the output voltage.

25. A method of supplying power to electronic components located on an agricultural planting implement wherein the agricultural planting implement is used with an agricultural vehicle, comprising the steps of:
supplying an input voltage from the agricultural vehicle to a voltage converter located on the agricultural planting implement;
allowing a user to provide user input;
selectively enabling or disabling the converter based on the user input;
converting the input voltage received by the converter to an output voltage produced by the converter when the converter is enabled, wherein the output voltage is different than the input voltage;
sending a signal to a relay switch when the converter is enabled;
closing the relay switch when the relay switch receives the signal, wherein when the relay switch is closed a plurality of row units on the agricultural planting implement will receive a power supply at a voltage equal to the output voltage; and
distributing the output voltage to one or more electronic components located on the plurality of row units;
wherein all electrical power supplied to the electronic components originates from a power source located on the agricultural vehicle.

26. The method of claim 25, wherein the converter is a DC to DC converter.

27. The method of claim 25, wherein the user input can include a command to manually enable or disable the converter or a command to allow the converter to automatically enable or disable based on the voltage needs of the one or more electronic components.
